(19) United States
(12) Patent Application Publication
(10) Pub. No.: US 2018/0232777 A1
(43) Pub. Date: Aug. 16, 2018

(54) Method and Apparatus Selling Internet Products and Services via Retail locations

(71) Applicant: Saul ELBAUM, Potomac, MD (US)

(72) Inventor: Saul ELBAUM, Potomac, MD (US)

(21) Appl. No.: 15/948,447

(22) Filed: Apr. 9, 2018

Related U.S. Application Data
(63) Continuation of application No. 13/754,960, filed on Jan. 31, 2013.

(51) Int. Cl. G06Q 30/02

(52) U.S. Cl. CPC G06Q 30/0269; G06Q 30/0259

(57) ABSTRACT

A method of enabling the sale of products or services which are available on the internet which comprises selecting a retail location, providing the retail location with information about products or services available on the internet which includes a website address at which the products or services may be purchased and a code for use in making purchases which is correlated with the identity of the retail location, storing the code in a computer which is not located at the retail location, programming the computer to monitor incoming signals received from purchasers and after a code which is the same as the stored code is received, provide an indication of the identity of the retail location which is correlated with the code, and paying a finder's fee to the retail location.

### FIELD OF THE INVENTION

This invention relates to a method and apparatus of enabling the sale of products or services on the internet using retail locations.

### BACKGROUND OF THE INVENTION

The traditional method of selling products is through a retail store that carries an inventory of products. Typically, a prospective customer will enter the retail store, find the product being sought and purchase it. The customer may also find other products of interest in the same store. A problem with the traditional method of selling products is that stores can only carry a limited amount of inventory. Some stores provide customers with computers which enable them to locate and purchase products which the store does not carry in inventory. In both cases, however, the store purchases products from a manufacturer, wholesaler or retailer and then resells the products to the customer. The store may receive the product from the product source and then deliver it to the customer, or the store may arrange for the product source to ship the product directly to the customer. In either case, the payment is made by the customer directly to the store.

The internet method of selling differs from the traditional method in that it enables customers to find the lowest prices for products being sought. However unlike a store in which the customer may walk through and find other products of interest, the internet does not generally display products other than those being searched. The internet simply finds what the customer is seeking. Thus, an internet search is a good way to find competing sources of certain products, and a retail store is a good way to find new product ideas.

This invention enables both to be accomplished. It makes available information about products or services in a retail location, it creates a good way to find new product ideas, and it does not require the retail location to carry inventory of the products. At the retail location, the customer receives product information and a code identifying the retail location. If the customer is interested, the purchase is made from the seller on the internet, and after the sale is completed, the seller pays a finder's fee to the retail location. The customer, if he desires, after becoming aware of the products may also search the internet for competing sources.

### SUMMARY OF THE INVENTION

In accordance with the invention, a method of enabling the sale of products or services which are available on the internet is provided, which comprises selecting a retail location, providing the retail location with information about products or services available on the internet which includes a website address at which the products or services may be purchased and a code for use in making purchases which is correlated with the identity of the retail location, storing the code in a computer which is not located at the retail location, programming the computer to monitor incoming signals received from purchasers and after a code which is the same as the stored code is received, to provide an indication of the identity of the retail location which is correlated with the code, and paying a finder's fee to the retail location.

The invention will be more fully understood by reference to the accompanying drawings, which are described as follows:

### BRIEF DESCRIPTION OF THE DRAWINGS

FIG. 1 is a block diagram illustrating the prior art method of retailing.

FIG. 2 is a block diagram illustrating an embodiment of the invention.

FIG. 3 is a block diagram of an embodiment of a computer which is used to perform the invention.

### DETAILED DESCRIPTION

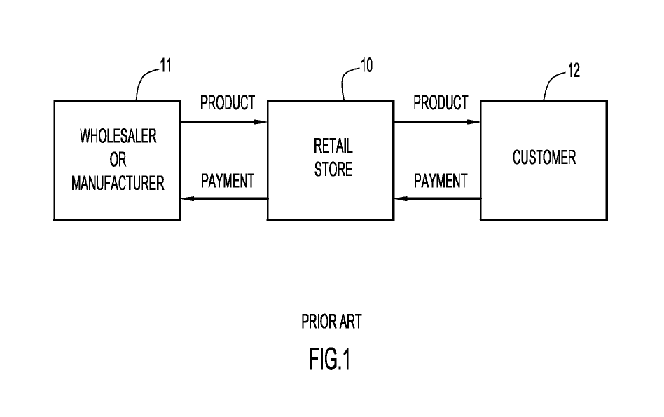

FIG. 1 illustrates the traditional prior art process in which a retail store 10 acquires product from a wholesaler or manufacturer 11 and then sells these products to its customer 12. The payments went first from the retail store to the wholesaler/manufacturer to purchase an inventory of the products, and then from the customer to the retail store to buy the products. This two-step process requires the retailer to invest in inventory and then wait for customers to come along and make individual purchases. Retailers are reluctant to hold large quantities of unsold inventories or products that occupy a large amount of space.

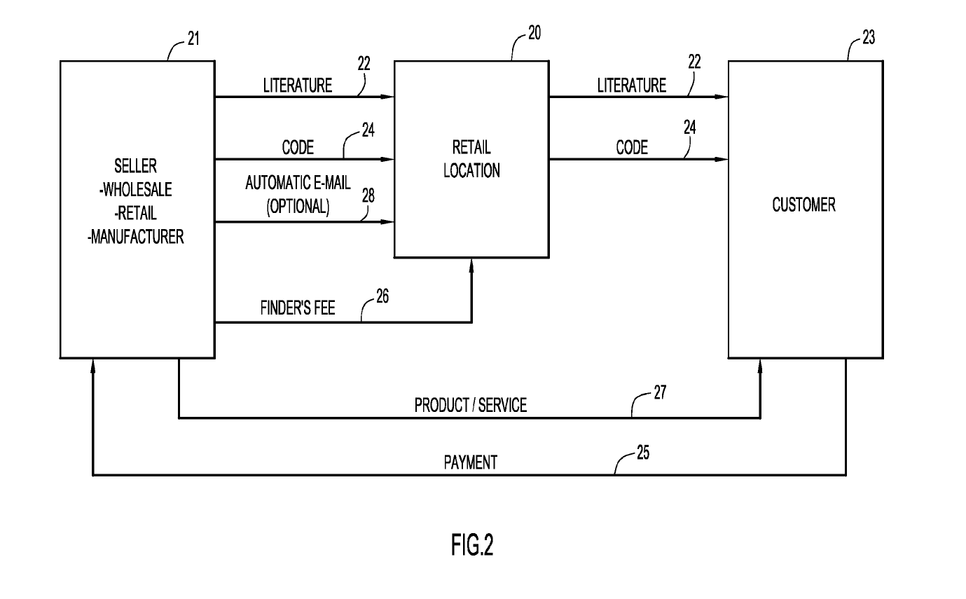

FIG. 2 illustrates an embodiment of the invention, in which the retail location 20 is not required to carry inventory. Instead, the retail location 20 carries display literature 22 such as pamphlets or brochures describing the product or products which are available from one or more sellers. In addition to products, the retail location 20 can also carry information about various services such as insurance, investment opportunities, beauty salons, etc. The literature 22 can be prominently displayed throughout the retail location 20 so that it's available to customers 23, and if desired, can be organized in various ways such as by subject matter, by end use, alphabetically, etc. The literature can be made available either free of charge or for a fee. The initial cost of providing the literature can be at the expense of the retail location 20 or of the sellers 21 of the various product and services. The information displayed could also be in audio-visual format, and/or include machine readable media such as a CD-ROM for the customer to take with him instead of or in addition to printed material.

In addition to acquiring literature about products and services, the prospective customer will acquire a code 24 from the retail location. The code will include information which is correlated with the identity of the retail location, to enable a computer under control of the seller to determine which retail location is entitled to a finder's fee. With the code 24 in hand, the customer can then log on to the internet to find the specific product or service of interest. The customer can then make a purchase directly from the seller 21 via payment 25, and the seller then proceeds to deliver the product 27 or service directly to the customer 23. Since the retail location has been identified by the use of code 24, the seller is able to pay a finder's fee 26 directly to the retail location 20. This enables the retail location 20 to make a profit without having invested in inventory.

The code 24 may also include information which enables a finder's fee to be calculated, and such information may, if desired, be correlated with a particular product or service. The above-mentioned computer may be programmed to compute such fee.

Additionally, the code 24 may include information which enables a discount to be calculated, and such information may be correlated with a particular product or service. The discount gives the customer an incentive to use the code 24 when the purchase is made, as otherwise the seller would not know whether or not the order was originated by a retail location, or was independently made by the customer.

After the sale is consummated, any future business matters such as returns, repairs, refunds or exchanges are conducted entirely between the customer 23 and the seller 21. The retail location 20 is not involved in these matters, although it may be required to refund the finder's fee in case of a product return.

An optional feature of the invention is automatic e-mail 28 which is sent by the seller's computer to the computer of the retail location confirming that a sale has been made, and including the details of the sale as well as the amount of the finder's fee which is attributable to the retail location. The automatic nature of the e-mail has the effect of increasing the confidence of the proprietor of the retail location in the integrity of the payment process. The computer may also be programmed to actually effect the payment.

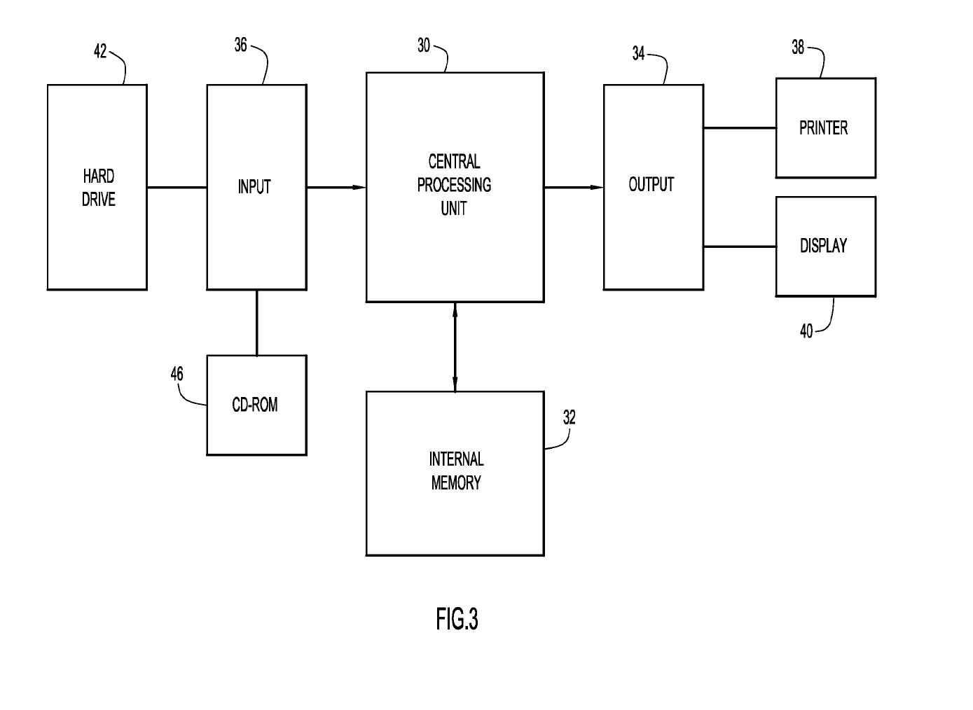

FIG. 3 is a block diagram of an embodiment of a computer which may be used for implementing the invention. It is comprised of central processing unit 30, main internal memory 32, output module 34, and input module 36. Also shown are peripherally located printer 38 and electronic display 40 which are interfaced with output module 34. At the input side, machine readable media are interfaced with input module 36. These may include a hard drive 42 as well as removable media, e.g., CD-ROM 46.

In the operation of an embodiment of the invention, a program to accomplish the functions which have been described above is loaded onto hard drive 42, e.g., from CD-ROM 46. In the alternative, the computer may operate directly from instructions received from removable media such as the CD-ROM. In either case, during operation, the application program is transmitted to main internal memory 32 where it is available to central processing unit 30.

With the application program loaded into the computer it is ready to accept incoming signals over the internet from purchasers of the products or services which the seller is marketing over the internet. The program includes codes 24 which are correlated with the identities of the retail outlets which are in the sales network. The computer is directed to monitor incoming sales information received over the internet. Also, the program instructs the central processing unit 30 to compare any received codes with those stored in memory 32. If a match is found, information including the identity of the retail location is fed to output module 34 and from there to printer 38 and/or display 40. Both the display and printer are conversion devices which convert the electrical signals outputted by output module 34 to a visual format.

The seller then knows which retail location is entitled to a finder's fee, and proceeds to pay such fee to the retail location. The program may also instruct the central processing unit 30 to compute the finder's fee based on information contained in code 24, so that it is not necessary for the seller to manually do so. Code 24 may also contain information which is correlated with a discount which the purchaser will receive, and in this case, information relating to the discount is stored in memory 32 and the central processing unit 30 is programmed to compute the discount, which is also fed to printer 38 and/or display 40. As mentioned above, an optional feature is the automatic transmittal of an e-mail to the computer of the retail outlet containing information relating to the sale including the finder's fee which is attributable to the retail outlet, and the program could include instructions to send such an e-mail.

The following describes one example, among many, of the applicability of the invention. A customer walks into a paint store intending to buy paint for his house. The customer then sees a brochure describing a new product, for example, the product described at www.rollerwall.com. The customer takes some literature about this product including a code, which is identified as a “discount code”. When the customer elects to buy this product on the internet, the customer enters the code and receives a reduced price. The code received by the customer also includes information relating to the identity of the retail location as well as information enabling a finder's fee to be calculated. After the sale is made, the seller sends a finder's fee to the paint store, which did not carry inventory. Thus the product supplier, Rollerwall, sold a product without the expense of up-front advertising, the paint store owner made a profit without the expense of inventory, and the customer found a unique product and acquired it at a discount.

In another example, which relates to services, a customer walks into a wallpaper store to find wallpaper. He then sees a brochure describing the qualifications of a wallpaper hanger. The customer takes some literature including a code, which contains information which is correlated with the identity of the retail location. When the customer elects to hire the wallpaper hanger, the store owner receives a finder's fee.

There are also customers who shop without a specific item in mind. Such a customer could walk into a retail location that carries information about many diverse products rather than actual products, or into a traditional store that carries actual products in addition to such information. The information could describe unique and unusual products or services available from sellers worldwide, and/or more conventional ones. The customer would browse this information to receive ideas about the products or services.

It is noted that the retail location could be a store, a part of a store, a kiosk in a mall, or other type of location which is capable of making the appropriate information available to customers. Also, in connection with the payment of a finder's fee it should be understood that the term “retail location” as used herein includes an entity or individual which the responsible authority connected with the retail location or its franchiser designates or requests to receive the payment. It should further be appreciated that the term “inventory” as used herein does not include samples or demonstrators which are not available for sale, and the term “computer” encompasses various embodiments including a cellular telephone which performs a processing function.

Thus, according to the invention, a method of enabling the sale of products or services which are available on the internet is provided. Additionally, a programmed computer for enabling the sale of products or services which are available on the internet is provided, as well as machine readable media bearing a set of instructions for a computer for enabling the sale of products or services which are available on the internet. Moreover, a method in which a plurality of sellers provides information to at least one retail location relating to products and services which such sellers offer on the internet, is provided.

It should be appreciated that while the invention has been described in connection with illustrative embodiments, variations which do not depart from the spirit of the invention may occur to those skilled in the art, and the subject matter intended to be covered is defined in the claims which are appended hereto.

1-19. (canceled)

20. A walk-in store that does not stock inventory of products for sale comprising:
a) a store containing printed literature descriptive of items available for sale on the internet, but not containing said items;
b) said store also containing website addresses where each of those items can be purchased;
c) said store also containing discount codes applicable to the purchase price of said items, said discount codes identifying the website of the sellers of each of said items;
d) means for enabling persons to use the discount codes when making purchases directly from the website of the sellers of each of said items; and
e) means for enabling the sellers of each of said items to identify and pay a finder's fee to the store that provided the discount code.

21. The store of claim 20 wherein said means for for enabling the sellers of each of said items to pay a finder's fee to the store comprises computer software available on the computers of the sellers.

22. The store of claim 21 wherein the items are products or services or both.

23. The store of claim 22 wherein the seller's computer provides information to the walk-in store regarding the sale and finder's fee.

24. The invention of claim 23 including means to pay the finder's fee directly to the walk-in store or to a third party.

25. A method of earning income from a walk-in store that does not stock inventory of products comprising:
a) furnishing the store with printed literature descriptive of items available for sale on the internet, but not furnishing the store with said items;
b) providing persons who visit the store with website addresses where those items can be purchased;
c) providing persons who visit the store with discount codes which are applicable to the purchase price of said items, said discount codes identifying the website of the sellers of each of said items;
d) enabling persons to use the discount codes when making purchases directly from the website of the sellers of each of said items; and
e) enabling the sellers to identify and pay a finder's fee to the store that provided the discount code.

26. The method of claim 25 wherein the means for enabling sellers to identify and pay a finder's fee to the walk-in store is software available to the seller's computer.

27. The method of claim 26 wherein the items are products or services or both.

28. The method of claim 27 wherein software from the seller's computer provides information to the computer of the walk-in store regarding the sale and the finder's fee.

29. The method of claim 28 wherein the finder's fee is paid directly to the store or to a third part.

30. A method of earning income from a walk-in store that does not stock inventory comprising:
a) providing the store with printed literature descriptive of items available for sale on the internet;
b) providing the store with website addresses where each of those items can be purchased directly from the sellers of said items;
c) providing discount codes associated with said items to enable persons to purchase said items directly from the seller's website;
d) making those items available for purchase at a discount from the prices published on the seller's website;
e) providing software accessible to the computers of said sellers, said software capable of recognizing said codes, implementing said discounts and enabling the payment of a finder's fee from the sellers of said items directly to the retail location identified by said discount codes.

31. The method of claim 30 wherein the software calculates the finder's fee and the discount for each item and delivers the finder's fee to the retail location.
